(19) United States
(12) Patent Application Publication
(10) Pub. No.: US 2021/0304133 A1
(43) Pub. Date: Sep. 30, 2021

(54) SYSTEMS AND METHODS FOR PREDICTING MACHINE DELIVERY

(71) Applicant: Caterpillar Inc., Peoria, IL (US)

(72) Inventors: SaiSudha Anandam, Morton, IL (US); Sripada Gopalarao Kuber, Morton, IL (US); Arjun V. Nemical, Bengaluru (IN)

(73) Assignee: Caterpillar Inc., Peoria, IL (US)

(21) Appl. No.: 16/831,570

(22) Filed: Mar. 26, 2020

(51) Int. Cl. G06Q 10/08; G06N 20/00

(52) U.S. Cl. CPC G06Q 10/0838; G06N 20/00

(57) ABSTRACT

A method includes determining, based at least in part on historical order data and a machine learning engine, lead times for machines and determining, based at least in part on historical shipping data and the machine learning engine, estimated delivery times to deliver the machines from an origin to a destination. The method also includes generating a predicted arrival function based at least in part on the estimated lead times and the estimated delivery times, receiving, via a network, an order identifier associated with an order made by the purchaser, the order number identifying an ordered machine, the origin of a seller, and the destination of a purchaser, determining, using the predicted arrival function, estimated delivery information, the estimated delivery information indicating a date at which the ordered machine is expected to arrive at the destination of the purchaser, and providing, via the network, the estimated delivery information to an electronic device associated with the purchaser.

### TECHNICAL FIELD

The present disclosure relates to a system for predicting an estimated delivery of a purchased machine. More specifically, the present disclosure relates to systems and methods for predicting at least an estimated delivery date for a machine purchased by a dealer from a seller of the machine.

### BACKGROUND

When a dealer (or other purchaser) has purchased machinery and/or equipment from a supplier, the dealer often needs to know when such purchases will arrive. Furthermore, large machinery, such as mining trucks for example, are typically shipped in a disassembled state, and thus, must be assembled once they have arrived at a dealer (or other customer) location. Therefore, technicians are often hired to assemble such machines and thus, must be scheduled in accordance with the arrival of a purchased machine at the dealer location. Additionally, a dealer typically expects the supplier to indicate the date on which a machine will arrive once purchased in order to adequately serve their respective customers and meet the needs of such customers.

However, a dealer is not typically informed of the status and estimated delivery date of a purchased machine until the machine has entered a shipping “life cycle” (e.g., once the machine has been shipped from the supplier). As such, the dealer often such a status of their purchase too late in a delivery process and will be unable to adequately plan ahead to schedule assembly technicians, provide their customers with an accurate delivery date, etc. Furthermore, during various portions of the delivery process, shipping updates are often infrequent, or absent altogether. Therefore, dealers are not provided with insight into various events during the delivery process and are often unaware of various delays in the delivery process.

An example system for tracking shipments is described in U.S. Pat. No. 6,873,963 (hereinafter referred to as “the '963 reference”). In particular, the '963 reference describes associating carrier information with supplier information in order to determine estimated delivery times for shipments made from a supplier to a manufacturer. The '963 reference describes receiving information from a supplier and receiving information from a carrier. The '963 reference further describes associating the information received from the supplier with the information received from the manufacturer in order to provide estimated delivery times for a specific type of material that will be delivered. The system described in the '963 reference is not, however, configured to provide an estimated delivery time prior to shipment of the purchased material. For instance, the '963 reference describes that an estimated delivery time may not be provided to a purchaser until a carrier has been booked to transport the material to the manufacturer. The system set forth in the '963 reference then relies on receiving information from the carrier in order to associate the carrier information with the supplier information to provide the estimated delivery time. As a result, the system described in the '963 reference is not configured to, among other things, provide an estimated delivery date prior to a shipping life cycle of purchased materials.

Example embodiments of the present disclosure are directed toward overcoming the deficiencies described above.

### SUMMARY

An example system includes one or more processors and memory storing computer-executable instructions that, when executed, cause the one or more processors to perform acts including determining a type of machine available for purchase from a seller, accessing historical order data associated with the type of machine, the historical order data including lead times for past orders of the type of machine, and accessing historical shipping data associated with the past orders, the historical shipping data including information associated with the past orders for machines shipped, from an origin to a destination. The operations further include generating, based in part on the historical order data and the historical shipping data, a predicted arrival model using a machine learning engine, wherein generating the predicted arrival model includes: determining an estimated lead time for the type of machine, the estimated lead time being determined based at least in part on the lead times for the past orders of the type of machine, and determining an estimated delivery time to deliver the type of machine from the origin to the destination. The operations also include receiving, via a network, an order identifier associated with a purchase made by a dealer and from a seller, of an ordered machine, the ordered machine being the type of machine, determining, based at least in part on the order identifier, a first location associated with the seller and a second location associated with the dealer, determining, based at least in part on the first location, the second location, and the predicted arrival model, estimated delivery information, the estimated delivery information indicating a date at which the ordered machine is expected to reach the second location, and providing, via the network, the estimated delivery information to an electronic device associated with the dealer.

An example method includes determining, based at least in part on historical order data and a machine learning engine lead times for one or more machines and determining, based at least in part on historical shipping data and the machine learning engine, estimated delivery times to deliver the one or more machines from an origin associated with a seller to a destination associated with a purchaser. The method also includes generating a predicted arrival function based at least in part on the estimated lead times and the estimated delivery times, receiving, via a network, an order identifier associated with an order made by the purchaser, the order number identifying an ordered machine, the origin of the seller, and the destination of the purchaser, determining, using the predicted arrival function, estimated delivery information, the estimated delivery information indicating a date at which the ordered machine is expected to arrive at the destination of the purchaser; and providing, via the network, the estimated delivery information to an electronic device associated with the purchaser.

In a further example, a method includes determining, based at least in part on historical shipping data and a machine learning engine, estimated delivery times to deliver one or more machines from an origin associated with a seller to a destination associated with a dealer and generating, based at least in part on the estimated delivery times and the machine learning engine, a predicted arrival model. The method also includes receiving, via a network, an order identifier associated with a purchase made by the dealer, the order number identifying a machine purchased by the dealer, determining, based in part on the order number, a first location associated with a seller selling the machine and a second location associated with the dealer, determining, using the predicted arrival model, estimated delivery information, the estimated delivery information indicating a date at which the machine is expected to arrive at the destination, determining, using the predicted arrival model and based on the estimated delivery information, a confidence score for the date, wherein the confidence score is based at least in part on the historical shipping data, and providing, via the network, the estimated delivery information and the confidence score to an electronic device associated with the dealer.

### BRIEF DESCRIPTION OF DRAWINGS

FIG. 1 is a schematic illustration of a machine delivery system in accordance with an example of the present disclosure.

FIG. 2 is a flowchart illustrating an example method of creating training data for generating a predicted arrival model in accordance with an example of the present disclosure.

FIG. 3 is a flowchart illustrating an example method of generating a predicted arrival model in accordance with an example of the present disclosure.

FIG. 4 is a flowchart illustrating an example method of deploying a predicted arrival model in accordance with an example of the present disclosure.

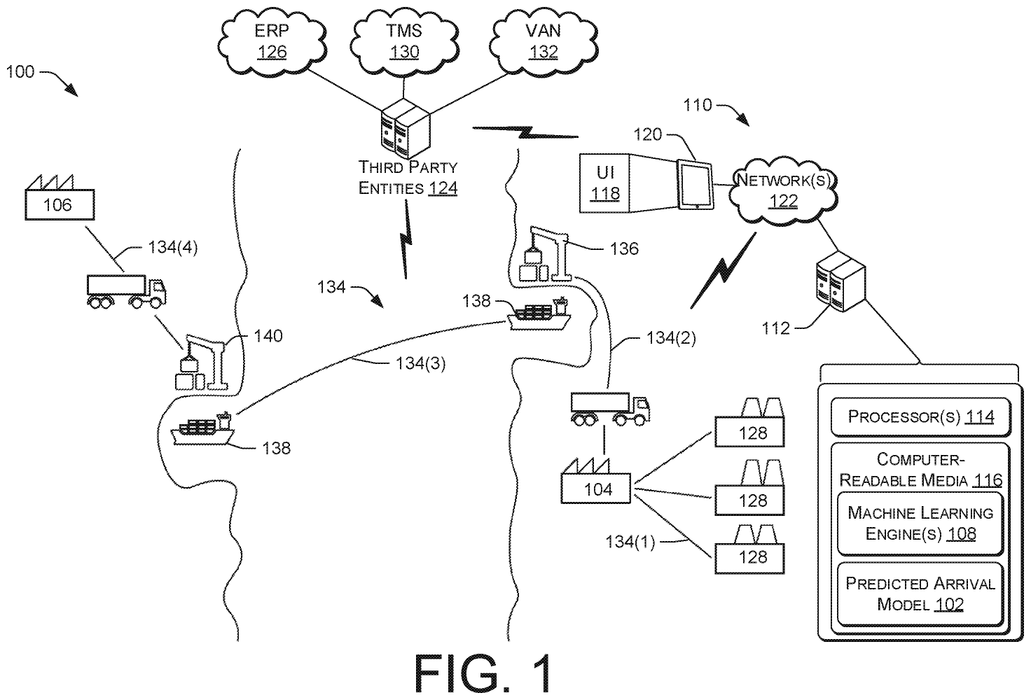

### DETAILED DESCRIPTION

Wherever possible, the same reference numbers will be used throughout the drawings to refer to the same or like parts. As shown in FIG. 1, and as will be described in detail below, an example machine delivery system 100 includes a predicted arrival model 102 configured to provide an estimated time/date of delivery prior to a shipping life cycle of ordered materials. The predicted arrival model 102 may determine the estimated delivery date for ordered materials that are shipped from a first location (also referred to herein as “an origin”) 104 associated with a seller of the purchased materials to a second location (also referred to herein as “a destination”) 106 associated with a purchaser (e.g., a dealer) of the ordered materials. The predicted arrival model 102 may be generated by one or more machine learning engines 108 based in part on historical shipping data and historical order data associated with previously ordered materials. Example methods of generating the predicted arrival model 102 will be described further herein below. As will also be explained throughout the present disclosure, the ordered materials include various machines, equipment, and/or components thereof. For ease of explanation, the various machines and equipment will be referred to collectively as “machines”. Such machines may include, but are not limited to, bulldozers, haul trucks, excavators, pavers, mining trucks, shovels, material handlers, graders, etc.

As mentioned previously, the predicted arrival model 102 is generated by one or more machine learning engines 108. The predicted arrival model 102 and/or the machine learning engines 108 may be stored on and executed by a computing system 110. The computing system 110 includes one or more computing devices 112 that perform various operations of the machine delivery system 100. The computing devices 112 include one or more processors 114 that may be a single processing unit or a number of processing units, and may include single or multiple computing units or multiple processing cores. The processors 114 are configured to access and/or execute computer-readable instructions stored in computer-readable media 116, such as one or more software modules or components. The computer-readable media 116 may include volatile and nonvolatile memory and/or removable and non-removable media implemented in any type of technology for storage of information, such as computer-readable instructions, data structures, program modules, or other data. Such computer-readable media 116 includes, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that may be used to store the desired information and that may be accessed by a computing device or other processor. Depending on the configuration of the computing devices 112 the computer-readable media may include a type of computer-readable storage media and may be a non-transitory storage media.

In some examples, the one or more machine learning engines 108 are stored on the computer-readable media 116. The machine learning engines 108 are configured to analyze the historical order data and/or the historical shipping data (collectively “historical data”) in order to determine an estimated delivery date for a purchased machine to arrive at the destination 106. Through an iterative process, the machine learning engines 108 may refine the predicted arrival model 102 until the predicted arrival model 102 is generating output within a predetermined range, as will be described further herein. In some examples, the computing system 110 may rely on one or more data maps, look-up tables, neural networks, algorithms, machine learning algorithms, data layers, predictive layers, and/or other components relating to the operating conditions and the operating environment of the machine delivery system 100 that are stored in the memory of the computing system 110. Each of the data maps noted above may include a collection of data in the form of tables, graphs, and/or equations to maximize the performance and efficiency of the machine delivery system 100 and its operation. Furthermore, the machine learning engines 108 may use feature reduction and/or feature selection algorithms to estimate a delivery date of a machine and/or to identify various factors that impact the delivery time of the machine. The delivery time may represent an amount of time that passes from a time that an ordered machine is ready to ship at the origin 104 until a time when the ordered machine is delivered at the destination 106. In such an example, the feature reduction and/or feature selection algorithms may include random forest regression models, Spearman's rank correlation between one or more factors, recursive feature elimination (RFE), principal component analysis (PCA), matrix factorization, diversity selection based on latent space from a matrix factorization, a Relief algorithm, or a combination thereof. In addition, through the one or more machine learning techniques, the predicted arrival model 102 learns various events, portions of a delivery route, and/or external factors (e.g., customs delays, port strikes, natural disasters, etc.) that have the greatest effect on the delivery time of a purchased machine from one location to another. Furthermore, the computing system 110 may calculate, from such information, a posterior probability (e.g., likelihood or confidence score) for an estimated delivery date.

The computing system 110 may generate a user interface 118 and will present the user interface 118 to a user via one or more electronic devices 120. The user interface 118 includes information regarding the estimated delivery date of an ordered machine to a purchaser, seller, and/or other user. As described previously, typical systems may be unable to provide an estimated delivery time until the ordered items enter a shipping lifecycle. However, the machine delivery system 100 described herein may provide an estimated delivery time to the dealer at the time the order is placed. The computing system 110 receives order data and shipping data via a network 122. The network 122 may be a local area network (“LAN”), a larger network such as a wide area network (“WAN”), or a collection of networks, such as the Internet. Protocols for network communication, such as TCP/IP, may be used to implement the network 122. Although examples are described herein as using a network 122 such as the Internet, other distribution techniques may be implemented that transmit information via memory cards, flash memory, or other portable memory devices.

In some examples, the computing system 110 may receive order data and shipping data via the network 122 from one or more third party entities 124. For example, the computing system 110 may receive order data from an enterprise resource planning (ERP) system 126. The ERP system 126 may include a supply chain management software that is provided by and/or managed by a third-party entity 124. The order data may be generated by the ERP system 126 based on an order placed by a purchaser for a machine and/or components thereof. The ERP system 126 is configured to receive order data from the purchaser and to send the order data to the computing system 110 via the network 118. Thus, the ERP system 126 manages one or more orders placed by a purchaser such as a dealer or other customer. In some examples, the ERP system 126 processes orders that are received from customers. For example, the ERP system 126 may be configured receive the order from the customer, determine available machines and/or components thereof, and send the order data to the computing system 110 and/or other systems. In some examples, the ERP system 126 analyzes inventory of a seller (and/or seller locations) to determine available machines and/or components thereof and may automatically send a request to one or more manufacturers 128 for one or more components of an ordered machine based on the available inventory of the seller. While described as a third-party entity 124, the ERP system 126 may be stored on an executed as a module on the computer-readable media 116 of the computing device 112.

In some examples, the manufacturers 128 may be in a different location (i.e., remote from) than the origin 104, and the time associated with the delivery of components from the respective manufacturers may contribute to a portion of a lead time associated with an ordered machine. The lead time may represent an amount of time that passes from a time when an order for a machine is received until the ordered machine is ready to be shipped. In some examples, the predicted arrival model 102 may determine the estimated delivery date based in part on lead times associated with the individual components or assemblies of the ordered machine. For example, the predicted arrival model 102 determines, from historical shipping data and/or historical order data (collectively “historical data”), lead times associated with previously ordered machines. The predicted arrival model 102 is configured to determine, from the historical data, an average amount of time elapsed between a first date (and/or time) when the purchaser places an order for a machine and a second date (and/or time) when each of the components (and/or assemblies) are prepared and the ordered machine is ready to be shipped to the purchaser. Furthermore, the predicted arrival model 102 may determine, from the historical data, lead times based on a type of machine ordered. The lead times account for events such as receiving components from suppliers, processing orders, manufacturing components, inspections, preparing the machine and components for delivery, etc. In response to a request for one or more components, the manufacturers 128 prepare (manufacture, assemble, prepare to ship, etc.) and send the requested components to the origin 104 associated with the seller of the ordered machine. In some examples, the ordered machine may be sent from multiple origins associated with the seller. For example, each component of the ordered machine may not arrive at a single origin 104 prior to being shipped to the destination 106. Rather, various components of the ordered machine are shipped directly to the destination 106 from their respective origin locations (whether from the manufacturer 128 or a location associated with the seller). Still further, the ordered machine may be sent from a specific location of the seller depending on the type of machine that is purchased by the dealer. For example, if a dealer purchases a mining truck from the seller, the seller may send the purchased mining truck from a first location. However, if the dealer purchases a bulldozer, the seller may ship the purchased bulldozer from a second location that is different than the first location. The predicted arrival model 102 may determine from the historical data which types of machines are sent from which specific locations.

As mentioned previously, once the order has been placed, the predicted arrival model 102 may generate an estimated delivery date (or estimated time of delivery) for the ordered machine to reach the destination 106. The predicted arrival model 102 may also determine a confidence score associated with the estimated delivery date and may provide the estimated delivery date and the confidence score to seller, purchaser, and/or other users. Additionally, and/or alternatively, the machine delivery system 100 may provide the dealer with an estimated delivery date prior to ordering the machine (i.e., as the dealer is considering purchasing the machine). For example, the computing system 110 may receive a request for an estimated delivery date for a specific type of machine from a dealer. The computing system 110 may deploy the predicted arrival model 102 to determine an estimated delivery date or may determine a delivery window (e.g., within 100-130 days) that the specific type of machine may be delivered in. In some examples, the predicted arrival model 102 may determine the estimated delivery date based on historical order data and historical shipping data. The historical shipping data may include shipping data received from previous shipments of ordered machines. For example, the historical shipping data may include an origin location, a destination location, a ship date (i.e., when the shipment left the origin), a weight of the shipment, a quantity of containers that the previously ordered machine was shipped in, a quantity of components and/or assemblies that were shipped, etc. When describing various dates herein, it is assumed that data regarding the various dates may also include a time of day or other temporal information. The historical shipping data may also include any shipping events (among other information) between the manufacturers 128 and the destination 106 (such as the dealer location). For example, the historical shipping data may include a date when the ordered machine was ready to ship, a ship date, a date when the shipment arrived at an intermediate location, a date when the shipment left the intermediate location, a stoppage in progress, a resumption of progress, a date that the shipment transferred carriers and/or modes of transportation, etc. In some examples, the historical shipping data may be generated by one or more third-party entities 124 and is sent to the computing system 110. In some examples, the historical shipping data includes domestic transit data and international or marine transit data. For example, domestic transit data may be generated by a domestic transportation management system 130 (TMS) that is configured to send domestic shipping data to the computing system 110. Furthermore, international and/or marine transit data may be generated by a marine transportation management system such as a value-added network 132 (VAN) that is configured to send the international and/or marine transit data to the computing system 110. Additionally, and/or alternatively, the computing system 110 may be in communication with other management systems associated with a same or similar entity as the computing system 110.

The historical shipping data includes information indicative of shipments made along a delivery route 134 for a shipping life cycle of the ordered machine. For example, the historical shipping data includes information regarding shipments made between intermediate locations along the delivery route (such as between the manufacturer 128 and the origin 104), a time/date a shipment was ready to ship, a time/date the shipments left a location, a carrier that transported the shipment, a dwell time representing an amount of time that the shipment was at an intermediate location, a time/date a shipment arrived at a location, etc. The historical shipping data may further include information indicating various delays and causes thereof. For example, the information may include information regarding an event that caused the delay and an amount of time that the shipment was delayed. The delivery route 134 may include one or more segments between intermediate locations on the delivery route 134. For example, the delivery route 134 may include a first segment 134(1) extending from the manufacturer 128 to the origin 102. In some examples, the first segment 134(1) represents a domestic shipping route taken to deliver one or more components of an ordered machine from the manufacturer 128 to the origin 102. In some examples, various components are transported from the manufacturer 128 to the origin 102 via truck, train, ferry, and/or other regional/domestic shipping methods. The delivery route 134 may also include a second segment 134(2) extending from the origin 102 to a first port 136. In some examples, the ordered machine is transported in a plurality of shipping containers. Similar to the first segment 134(1), the ordered machine may be transported from the origin 102 to the first port 136 via regional/domestic shipping methods. In some examples, the destination 106 may be located in the same country as the origin 102 and, as such, the ordered machine may be shipped domestically between various shipping hubs.

Once the ordered machine has reached the first port 136, the ordered machine may be loaded onto a shipping vessel 138. The historical shipping data may include a dwell time representing an amount of time that the ordered machine spends at the port before being loaded on the shipping vessel 138. The shipping vessel 138 may carry the ordered machine along a third segment 134(3) of the delivery route 134. In some examples, the third segment 134(3) may extend across ocean(s) and/or sea(s). In some examples, the ordered machine (or components thereof) is transported along the third segment 134(3) (or other segments of the delivery route 134) by airplane or other shipping method. Once the shipping vessel 138 has traversed the third segment 134(3) of the delivery route 134, the ordered machine is unloaded (or otherwise transferred) at a second port 140. In some examples, the third segment 134(3) may be between two countries on a same continent and thus, the ordered machine may not traverse an ocean or sea and will enter other countries through a specified port of entry. In any example, once arriving in another country the ordered machine may pass through customs. The historical shipping data may also include an amount of time that the ordered machine spent in customs. In some examples, once the ordered machine passes through customs and/or is unloaded at the second port 140, the ordered machine may be loaded on another domestic mode of transportation and may traverse a fourth segment 134(4) of the delivery route 134. Upon traversing the fourth segment 134(4) the ordered machine may arrive at the destination 106.

While describing the delivery route 134 as having four segments, the delivery route may include fewer or additional segments and/or intermediate locations. The computing system 110 may receive shipping data indicative of these and other events involved in the delivery of the ordered machine to the destination 106. As mentioned previously, the computing system 110 stores such data as historical shipping data and stores the shipping data for each machine that is sold and delivered to dealers and/or other customers. Based on the historical order data and the historical shipping data, the computing system 110 is configured to track an amount of time that a machine takes to be delivered to the destination 106 once the dealer has ordered the machine. For example, the computing system 110 may determine an estimated traversal time for the ordered machine to traverse one or more of the segments described above. If the computing system 110 determines, from received shipping data, that the ordered machine has not traversed the one or more segments within the estimated traversal time, the computing system 110 may send a notification to the seller.

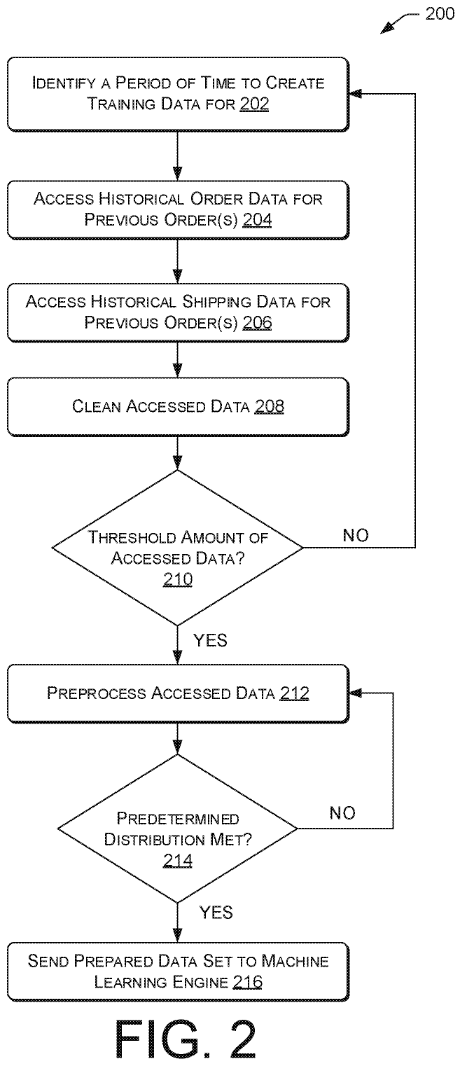

As mentioned previously, the estimated delivery date may be generated by the predicted arrival model 102. FIG. 2 depicts an example method 200 of creating training data for generating the predicted arrival model 102 based on the machine learning engines 108. The example method 200 is illustrated as a collection of steps in a logical flow diagram, which represents operations that may be implemented in hardware, software, or a combination thereof. In the context of software, the steps represent computer-executable instructions stored in memory. Such computer-executable instructions may include routines, programs, objects, components, data structures, and the like that perform particular functions or implement particular abstract data types. The order in which the operations are described is not intended to be construed as a limitation, and any number of the described steps may be combined in any order and/or in parallel to implement the process. For discussion purposes, and unless otherwise specified, the method 200 is described with respect to the machine delivery system 100 and the computing system 110 described in FIGS. 1 and 2.

With reference to FIG. 2, at 202 the computing system 110 may identify a period of time to create training data for. In some examples, the computing system 110 may create training data for any previous orders for which historical data is available. For example, when initially creating training data in order to generate the predicted arrival model 102, the computing system 110 may access any available historical data to generate the predicted arrival model 102. Additionally, and/or alternatively, the computing system 110 may identify a limited period of time for which training data will be created. For example, the computing system 110 may be configured to create training data based on historical data for the previous x-months (e.g., 6 months) of completed orders. In some examples, the computing system 110 may receive input from a user identifying the period of time for which training data should be created. Additionally, and/or alternatively, the computing system 110 may identify a period of time for which training data has not been previously generated.

At 204, the computing system 110 may access historical order data for previously ordered machines. In some examples, the computing system 110 may access the historical order data for the period of time (e.g., the previous 6 months) identified at 202. For example, the computing system 110 may access historical order data for the previous 6-months of completed orders. The historical order data may include information regarding a type of machine that was ordered. As such, the computing system 110 may access historical order data for each type and/or model of machine offered for sale by the seller. Additionally, the computing system 110 may determine from the historical order data various configurations for previously ordered machines. In some examples, the historical order data may include a dealer (or other customer) that purchased a machine, the type and/or model of machine that was purchased, a specific configuration of the machine requested by the dealer (e.g., various options that may be available such as work tools, implements, attachments, assemblies, or other machine features), lead times associated with ordered machines, build times for the machine, manufacturer(s) that provided various components, an origin location of the machine (i.e., where the machine was shipped from), a destination associated with the dealer (or other customer) (i.e., where the machine was shipped to), backorders associated with one or more components, availability of components etc. In some examples, the computing system 110 is in communication with a database that stores the historical order data.

At 206, the computing system 110 may access historical shipping data for previously ordered machines. In some examples, the computing system 110 may access the historical shipping data for the period of time (e.g., the previous 6 months) identified at 202. In some examples, the historical shipping data includes information regarding the origin 104 and the destination 106 of previously shipped machines. Furthermore, the historical shipping data may include information regarding the types of machines that were previously ordered, a weight of the shipment, a quantity of containers that the previously ordered machines were shipped in, a quantity of components and/or assemblies that were shipped, etc. As mentioned previously, the computing system 110 may receive the historical shipping data from one or more third-party entities 124 such as the TMS system 130 and/or the VAN 132. Additionally, and/or alternatively, the computing system 110 may be in communication with one or more internal management systems that may generate and send the shipping data to the computing system 110. The historical shipping data includes any data associated with transportation of a shipment of from one location to another. For purposes of this disclosure the term “shipment” may refer to the transportation of one or more components, assemblies, and/or the transportation of the machine itself (in an assembled, disassembled, or partially assembled state). For example, the historical shipping data may include, but is not limited to, an indication that a shipment is ready to ship from a location, an origin of one or more components, an origin of the machine once the machine arrive at the origin (i.e., all the components have arrived at a location and are ready to ship), a destination of the machine, a delivery route 134 of the machine, one or more intermediate locations along the shipping route, dwell times for various locations, various delays and causes thereof, time spent in customs, time spent being transferred from one mode of transportation to another, etc.

Once the computing system 110 has accessed the historical order data and/or the historical shipping data, the computing system 110 may clean the accessed data at 208. For example, the computing system 110 may remove unwanted data and/or incomplete data (i.e., data that is missing dates or other critical information). Furthermore, the computing system 110 may determine whether the accessed data includes a high variance from other historical data and may remove outlying data points.

At 210, the computing system 110 may determine whether an amount of remaining accessed data (once cleaned) is adequate for creating training data. In some examples, the computing system 110 may receive input indicative of a threshold specifying an amount of accessed data that the computing system 110 requires in order to create training data. If, at 210—Yes, the computing system 110 determines that the amount of accessed data is equal to or greater than the threshold amount, the computing system may preprocess the accessed data at 212. If, at 210—No, the computing system 110 determines that the amount of accessed data is below the threshold amount, the computing system may return to 202 and may adjust the period of time for which to create training data. For example, if the computing system 110 determines that, after cleaning accessed data for a time period of the last 3 months, there is not a threshold amount of accessed data, the computing system 110 may determine to extend the period of time to 6 months in order to gather enough complete data to create training data for the machine learning engines 108.

As mentioned previously, if the computing system 110 determines that there is a threshold amount of accessed data the computing system 110 preprocesses the accessed data using one or more data preprocessing modules at 208. For example, the computing system 110 may convert categorical data to numeric data. In some examples, the computing system 110 may convert the categorical data into numerical data by implementing integer encoding, one-hot-encoding, and/or other methods. Furthermore, the computing system 110 may convert the categorical data to numerical data by using label encoders to encode categorical data. Additionally, and/or alternatively, the computing system 110 may combine different levels of categorical data using business logic and/or using frequency or response rate. These and/or other methods may be used in order to convert the historical order data and/or the historical shipping data into formats that are acceptable to a machine learning engine 108. Furthermore, the computing system 110 may normalize the accessed data by feature scaling and/or other methods. Furthermore, the computing system 110 may implement one or more preprocessing packages available in a scikit-learn library to preprocess the historical data.

At 210, the computing system 110 may determine if preprocessing the accessed data at 208 results in a predetermined distribution of the processed data set. For example, the accessed data may be preprocessed until the preprocessed data includes a zero mean and unit variance (i.e., until a Gaussian distribution of the accessed data is created). Additionally, and/or alternatively, the computing system 110 may receive input from a user specifying a mean value (or mean value range) and a variance value (or variance value range) that are acceptable for preprocessed data. The computing system 110 may compare the preprocessed data with the respective acceptable values and/or value ranges. If, at 210—No, the computing system 110 determines that preprocessing the accessed data does not result in the predetermined distribution, the computing system may continue to normalize, scale, or otherwise preprocess the data in order to achieve the predetermined variance. If, at 210—Yes, the computing system 110 determines that preprocessing the accessed data resulted in the predetermined distribution, the computing system 110 sends the prepared data sent to a machine learning engine at 212. In some examples, the method 200 of FIG. 2 may be repeated for various periods of time and/or various types of machines offered for sale by the seller 102. Thus, the computing system 110 may prepare training data for various types, models, and/or specific configurations of machines. Additionally, and/or alternatively, the computing system 110 may repeat the method 200 described in FIG. 2 at regular intervals (e.g., weekly, monthly, quarterly, yearly, etc.) in order to consistently update the data that is sent to the machine learning engine 108. Thereby, the computing system 110 may retrain the predicted arrival model 102 as orders are completed and may account various order and/or shipping trends.

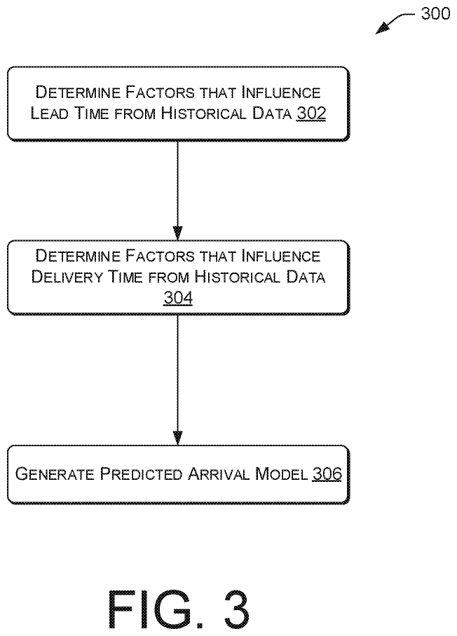

Once the training data has been created, the training data is sent to the machine learning engines 108 that may generate the predicted arrival model 102. FIG. 3 depicts an example method 300 of generating a predicted arrival model based in part on a machine learning engine. The example method 300 is illustrated as a collection of steps in a logical flow diagram, which represents operations that may be implemented in hardware, software, or a combination thereof. In the context of software, the steps represent computer-executable instructions stored in memory. Such computer-executable instructions may include routines, programs, objects, components, data structures, and the like that perform particular functions or implement particular abstract data types. The order in which the operations are described is not intended to be construed as a limitation, and any number of the described steps may be combined in any order and/or in parallel to implement the process. For discussion purposes, and unless otherwise specified, the method 300 is described with respect to the machine delivery system 100 and the computing system 110 described in FIGS. 1 and 2.

At 302, the machine learning engine 108 may determine, from the historical data (e.g., preprocessed historical order data and/or historical shipping data), one or more factors that influence (i.e., increase or reduce) lead times associated with previous orders. The lead time may represent an amount of time that passes from a time when an order for a machine is received until the ordered machine is ready to be shipped. In some examples, the machine learning engine 108 determines past lead times from the historical order data and the historical shipping data. The machine learning engine 108 may also determine the past lead times based on the origin 104 of previous orders, the type of machines previously ordered, the destination 106 of the ordered machines, etc. In some examples, the machine learning engine 108 determines common and correlated factors that influence the lead time. Such factors may include the type of machine that is ordered, the configuration of the ordered machine, the origin, the destination, etc. For example, the machine learning engine 108 may filter the historical data by types of machines that are ordered and may determine past lead times based on a specific type of machine that is ordered. The machine learning engine 108 may also determine trends in the historical order data such as what types of machines a certain dealer tends to purchase, times of year during which some types of machines are more likely to be ordered, locations from which machines are sent, etc. In some examples, the machine learning engine 108 uses a feature reduction and/or feature selection algorithm to identify one or more factors that influence (or will impact) the lead time of an ordered machine. In such an example, the feature reduction and/or feature selection algorithm may include Spearman's rank correlation between one or more factors, recursive feature elimination (RFE), random forest regression, principal component analysis (PCA), matrix factorization, diversity selection based on latent space from a matrix factorization, a Relief algorithm, or a combination thereof. The machine learning model 108 may also determine weights to apply to each of the identified factors that influence the lead times. Such weights may be applied by the predicted arrival model 102 when determining an estimated delivery date for future orders.

At 304, the machine learning engine 108 may determine, from the historical data, one or more factors that influenced delivery times for previous orders. The delivery time represents an amount of time that passes from a time that an ordered machine is ready to ship at the origin 104 until a time when the ordered machine is delivered at the destination 106. As such, the delivery time represents an amount of time that an ordered machine spends in the shipping life cycle. The machine learning engine 108 may determine past delivery times based on the historical order data and the historical shipping data. The machine learning engine 108 also determines past delivery times based on the origin 104 of previous orders, the type of machine previously ordered, the destination of the ordered machine, the delivery route of the ordered machine, etc. The machine learning engine 108 determines common and correlated factors that influence the delivery time. For example, the machine learning engine 108 may determine a correlation between a weight of the ordered machine and the delivery time, a correlation between a quantity of containers that the ordered machine is shipped in and the delivery time, various carriers that transport the ordered machine and the delivery time, a correlation between a delivery route 134 and the delivery time, etc. As with 302, the machine learning engine 108 may use a feature reduction and/or feature selection to identify one or more factors that influence the delivery time of an ordered machine. In such an example, the feature reduction and/or feature selection algorithm may include Spearman's rank correlation between one or more factors, recursive feature elimination (RFE), random forest regression, principal component analysis (PCA), matrix factorization, diversity selection based on latent space from a matrix factorization, a Relief algorithm, or a combination thereof. The machine learning model 108 may also determine weights to apply to each of the identified factors that influence the delivery times. Such weights may be applied by the predicted arrival model 102 when determining an estimated delivery date for future orders. In some examples, the machine learning engine 108 determines an amount of time for a shipment to traverse each of the one or more segments along the delivery route 134 based on historical shipping data that corresponds with the one or more segments (and/or other historical shipping data that does not directly correspond with the one or more segments). The machine learning engine 108 may use such information in order to determine an estimated delivery date for future orders.

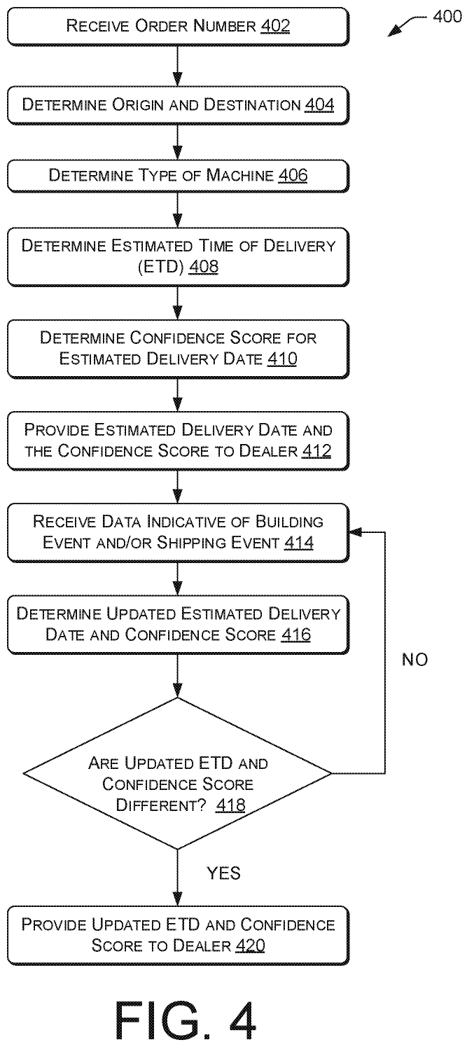

At 306, the computing system 110 may generate the predicted arrival model 102 based in part on the factors that influence the lead time and/or the factors that influence the delivery time. In some examples, the machine learning engine 108 may iteratively process the historical data until the predicted arrival model 102 is optimized. Such a process may include setting various hyperparameters and optimizing one or more parameters. In some examples, one or more modules and/or programs may be used for hyperparameter tuning to derive an optimized model. The computing system 110 may create a parameter grid to sample from while fitting the training dataset to known variables. During each iteration, the machine learning algorithm 108 may choose a different combination of features. The parameter grid may include a number of trees in a random forest regression model, a number of features to consider at every split, a maximum number of levels in a tree, a minimum number of samples requires to split a node, a minimum number of samples required at each leaf node, a method of selecting samples for training each tree, etc. After fitting the data, the optimized parameters may be determined by the machine learning engines 108 and from the optimized parameters, the hyperparameter may be determined. Furthermore, in some examples, the historical data is collected, a statistical model is formulated as described above, the predicted arrival model 102 generates estimated delivery dates, and the predicted arrival model 102 is validated and/or revised based on additional data that is received from completed orders. FIG. 4 describes in detail how the predicted arrival model 102 may be deployed.

FIG. 4 depicts an example method 400 of deploying the predicted arrival model 102. The method 400 of FIG. 4 may deploy the predicted arrival model that is generated in FIG. 3. The example method 400 is illustrated as a collection of steps in a logical flow diagram, which represents operations that may be implemented in hardware, software, or a combination thereof. In the context of software, the steps represent computer-executable instructions stored in memory. Such computer-executable instructions may include routines, programs, objects, components, data structures, and the like that perform particular functions or implement particular abstract data types. The order in which the operations are described is not intended to be construed as a limitation, and any number of the described steps may be combined in any order and/or in parallel to implement the process. For discussion purposes, and unless otherwise specified, the method 400 is described with respect to the machine delivery system 100 and the computing system 110 described in FIGS. 1 and 2.

At 402, the computing system 110 receives an order number associated with a machine that has been ordered by a dealer (or other customer). The computing system 110 may receive such an order number from the dealer and/or from the ERP system 126 described above. From the order number, the computing system 110 accesses order data that is associated with the order number. The order data may be stored in the ERP system, the TMS system, and/or the marine VAN provider system. The order data includes a machine that has been ordered, a configuration of the ordered machine, an origin location of the machine, a destination of the machine, one or more carriers that have been booked to transport the machine to the destination, etc.

At 404, the computing system 110 determines, from the order number and data associated therewith, the origin 104 of the ordered machine and the destination 106 of the ordered machine. In some examples, the origin 104 may be specified in the order data. However, in some examples, the computing system 110 may determine the origin 104 based on the order number and the predicted arrival model 102. For example, the computing system 110 determines, at 406, a type of machine that is ordered from the order data. Based in part on the type of machine, the predicted arrival model 102 determines the origin of the ordered machine based on past orders and origins for various types of machines that were previously ordered. In some examples, the origin may be a port. For example, the seller may have all the components of the machine arrive at a port (or other shipping hub) instead of first arriving at a seller location.

At 408, the computing system 110 determines, via the predicted arrival model 102, an estimated delivery date for the ordered machine to arrive at the destination 106. The estimated delivery date includes an estimated delivery date (e.g., Jul. 1, 2020) and/or estimated delivery range (e.g., Jul. 1, 2020-Jul. 5, 2020). In some examples, the predicted arrival model 102 determines the estimated delivery date based on the origin, the destination, and/or shipping trends therebetween in the historical shipping data. Furthermore, the predicted arrival model 102 may determine the estimated delivery date based on the various carriers that are contracted to transport the ordered machine from the origin 104 to the destination 106. Such a determination may be made at least in part on determining, from previously completed orders, average times that one or more carriers take to transport the ordered machine across one or more segments of the delivery route 134. Still further, the predicted arrival model 102 may determine the estimated delivery date based at least in part on the delivery route 118 and/or the segments thereof, intermediate locations between segments, specific ports that the ordered machine must travel through, specific customs checkpoints that the ordered machine must be approved by, environmental factors, etc. Such factors may be identified and weighted during the generation of the predicted arrival model 102 according to FIG. 3. The predicted arrival model 102 may determine weights for individual factors. The weights may calibrate or apportion the influence of the respective individual factors. In some examples, the predicted arrival model 102 may be updated over time by the machine learning engines 108 as data correlations evolve over time.

At 410, the predicted arrival model 102 may determine a confidence score for the estimated delivery date based on the one or more factors described herein. The confidence score may represent a likelihood or a posterior probability that the ordered machine will arrive by the estimated delivery date. In some examples, the confidence score may be calculated using a root mean square error calculation. The confidence score may be determined based on the quality of the historical data, consistency of delivery times from the origin 104 to the destination 106, an amount of historical data that is available for previously ordered machines that were delivered along a same or similar delivery route (and/or segments thereof), etc.

At 412, the computing system 110 provides the estimated delivery date and the confidence score to the dealer (or other customer) who ordered the machine. However, in some examples, the computing system 110 may not provide the confidence score to the dealer 106. The computing system 110 provides the estimated delivery date and the confidence score to the dealer via an electronic device associated with the dealer. The electronic device includes a user interface 118 that may be at least partially generated by the computing system 110.

At 414, the computing system 110 may receive data indicative of a building event and/or a shipping event. The computing system 110 may receive such data from the one or more third-party entities 124. The building events include information that: one or more components are available, all components of the ordered machine have arrived at the origin 102, the ordered machine is in a quality check, one or more components are at a paint station, the ordered machine is ready to ship, etc. The shipping events includes information indicative that: one or more components are ready to ship to the origin 104, the ordered machine is ready to ship from the origin 104, the ordered machine has been loaded in one or more containers, the ordered machine has been loaded on one or more modes of transportation, the ordered machine has arrived at an intermediate location, the ordered machine has departed an intermediate location, the ordered machine has cleared customs, the ordered machine is delayed, etc.

At 416, the predicted arrival model 102 may determine an updated estimated delivery date and an updated confidence score based on the shipping event and/or the building event. For example, the predicted arrival model 102 updates the estimated delivery date and/or the confidence score based in part on a date of the building event and/or the shipping event. Furthermore, the predicted arrival model 102 may update the estimated delivery date and/or the confidence score based in part on the event that occurred. For example, the predicted arrival model 102 determines that certain events strongly correlate to an alteration in the estimated delivery date.

At 418, the computing system 110 may determine whether the update estimated delivery date and/or the updated confidence score are different than the originally determined estimated delivery date and confidence score. If at 518—Yes, the values are different, then the computing system 110 provides the update estimated delivery date and the updated confidence score to the dealer. However, if at 518—No, the computing system 110 determines that the values are substantially similar, the computing system 110 may not provide the updated estimated delivery date and the updated confidence score to the dealer and will continue to receive shipping and building events, updating the estimated delivery date and the confidence score accordingly.

### INDUSTRIAL APPLICABILITY

The present disclosure describes systems and methods for estimating a delivery of an ordered machine from the time the machine is ordered by a customer such as a dealer. The systems and methods described herein use machine learning engines to generate a predicted arrival model that generates the estimated delivery date based on the origin of the machine, the destination of the machine, and/or the type of machine that is ordered. For example, such systems and methods configure a computing system 110 to receive, process, and analyze shipping data and/or order data. The analyzed data is used to generate the predicted arrival model 102 that determines the estimated delivery date and a confidence score thereof. The computing system 110 provides the estimated delivery date and the confidence score to the dealer. During the shipment of an ordered machine, the computing system 110 receives information associated with building events and/or shipping events thereby tracking the progress of the ordered machine. The predicted arrival model 102 may update the estimated delivery date and/or confidence score according to the progress of the ordered machine. The computing system 110 provides the estimated delivery date prior to the ordered machine entering a shipping life cycle, in some examples.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system comprising:
one or more processors; and
memory storing computer-executable instructions that, when executed, cause the one or more processors to perform acts comprising:
determining a type of machine available for purchase from a seller;
accessing historical order data associated with the type of machine, the historical order data including lead times for past orders of the type of machine; and
accessing historical shipping data associated with the past orders, the historical shipping data including an origin and a destination associated with the past orders;
generating, based in part on the historical order data and the historical shipping data, a predicted arrival model using a machine learning engine, wherein generating the predicted arrival model includes:
determining an estimated lead time for the type of machine, the estimated lead time being determined based at least in part on the lead times for the past orders of the type of machine; and
determining an estimated delivery time to deliver the type of machine from the origin to the destination;
receiving, via a network, an order identifier associated with a purchase made by a dealer and from a seller, the order identifier identifying an ordered machine that is characterized by the type of machine;
determining, based at least in part on the order identifier, a first location associated with the seller and a second location associated with the dealer;
determining, based at least in part on the first location, the second location, and the predicted arrival model, estimated delivery information, the estimated delivery information indicating a date at which the ordered machine is expected to reach the second location; and
providing, via the network, the estimated delivery information to an electronic device associated with the dealer.

2. The system according to claim 1, wherein the acts further comprise creating training data used to generate the predicted arrival model by removing incomplete data from the historical order data and the historical shipping data.

3. The system according to claim 1, wherein the acts further comprise:
determining a confidence score for the estimated delivery information, wherein the confidence score is based in part on a quality of the historical order data and the historical shipping data or consistency of historical delivery times for past orders delivered from the first location to the second location; and
providing, via the network, the confidence score to the electronic device associated with the dealer.

4. The system according to claim 3, wherein the acts further comprise:
receiving, from a carrier system, information indicative of a shipping event during transit of the ordered machine from the first location to the second location;
determining, based on the predicted arrival model, an updated estimated delivery date for the ordered machine based on the shipping event;
determining, based on the predicted arrival model, an updated confidence score for the updated estimated delivery date based on the shipping event; and
providing, via the network, the updated estimated delivery date and the updated confidence score to the electronic device associated with the dealer.

5. The system according to claim 1, wherein the acts further comprise:
identifying a delivery route for the ordered machine, the delivery route having one or more segments; and
determining an expected traversal time for each of the one or more segments of the delivery route, the expected traversal time representing an amount of time required for the ordered machine to traverse each of the one or more segments.

6. The system according to claim 5, wherein the acts further comprise:
determining that an actual traversal time has exceeded the expected traversal time; and
providing, via the network, a notification to the seller indicating that the ordered machine is delayed based on the actual traversal time exceeding the expected traversal time.

7. The system according to claim 1, wherein the historical shipping data includes domestic shipping data and oceanic shipping data.

8. The system according to claim 1, wherein the acts further comprise:
determining dwell times for one or more intermediate locations between the first location and the second location;
determining that the ordered machine has been at an intermediate location of the one or more intermediate locations longer than a dwell time for the intermediate location; and
providing, via the network, a notification to the seller indicating that the ordered machine has been at the intermediate location longer than the dwell time.

9. A method comprising:
determining, based at least in part on historical order data and a machine learning engine, estimated lead times for one or more machines;
determining, based at least in part on historical shipping data and the machine learning engine, estimated delivery times to deliver the one or more machines from an origin associated with a seller to a destination associated with a purchaser;
generating a predicted arrival function based at least in part on the estimated lead times and the estimated delivery times;
receiving, via a network, an order identifier associated with an order made by the purchaser, the order identifier identifying an ordered machine, the origin of the seller, and the destination of the purchaser;
determining, using the predicted arrival function, estimated delivery information, the estimated delivery information indicating a date at which the ordered machine is expected to arrive at the destination of the purchaser; and
providing, via the network, the estimated delivery information to an electronic device associated with the purchaser.

10. The method according to claim 9, wherein the estimated lead times includes an amount of time to receive one or more components of the one or more machines from a supplier, and the estimated delivery information is determined based at least in part on the estimated lead times.

11. The method according to claim 9, further comprising determining, based at least in part on the order identifier, one or more carriers that are contracted to transport the ordered machine, wherein the estimated delivery information is determined based at least in part on the one or more carriers.

12. The method according to claim 9, further comprising:
receiving, via the network, information indicative of a build event occurring during a build phase of the order;
determining, using the predicted arrival function and based at least in part on the build event, updated delivery information for the ordered machine; and
providing, via the network, the updated delivery information to the electronic device associated with the purchaser.

13. The method according to claim 9, further comprising:
receiving, via the network, information indicative of a shipping event occurring during a shipping phase of the order;
determining, using the predicted arrival function and based at least in part on the shipping event, updated delivery information for the ordered machine; and
providing, via the network, the updated delivery information to the electronic device associated with the purchaser.

14. The method according to claim 9, further comprising:
determining, using the predicted arrival function, a confidence score for the estimated delivery information, wherein the confidence score is based in part on historical delivery times from the origin to the destination; and
providing, via the network, the confidence score to the electronic device associated with the purchaser.

15. A method comprising:
determining, based at least in part on historical shipping data and a machine learning engine, estimated delivery times to deliver one or more machines from an origin associated with a seller to a destination associated with a dealer;
generating, based at least in part on the estimated delivery times and the machine learning engine, a predicted arrival model;
receiving, via a network, an order identifier associated with a purchase made by the dealer, the order identifier identifying a machine purchased by the dealer;
determining, based in part on the order identifier, a first location associated with a seller selling the machine and a second location associated with the dealer;
determining, using the predicted arrival model, estimated delivery information, the estimated delivery information indicating a date at which the machine is expected to arrive at the destination;
determining, using the predicted arrival model and based on the estimated delivery information, a confidence score for the date, wherein the confidence score is based at least in part on the historical shipping data; and
providing, via the network, the estimated delivery information and the confidence score to an electronic device associated with the dealer.

16. The method according to claim 15, further comprising determining, based at least in part on historical order data and the machine learning engine, estimated lead times for one or more machines, wherein the predicted arrival model is generated based in part on the estimated lead times.

17. The method according to claim 15, further comprising creating training data for the predicted arrival model by:
determining the one or more machines available for purchase from a seller;
accessing historical order data associated with the one or more machines, the historical order data including information associated with lead times for past orders; and
accessing the historical shipping data associated with the one or more machines, the shipping data including delivery times associated with previous orders that are shipped from an origin associated with the seller to a destination associated with a dealer.

18. The method according to claim 15, further comprising determining, based at least in part on the order identifier, one or more carriers that are contracted to transport the machine, wherein the estimated delivery information is determined based at least in part on the one or more carriers.

19. The method according to claim 15, further comprising:
identifying, using the predicted arrival model, a delivery route for the machine and one or more segments along the delivery route;
determining an expected traversal time for each of the one or more segments of the delivery route, the expected traversal time indicating an expected time for the machine to traverse each of the one or more segments;
determining that an actual traversal time of the machine has exceeded the expected traversal time; and
providing, via the network, information to the seller indicating that the machine is delayed based on the actual traversal time exceeding the expected traversal time.

20. The method according to claim 15, wherein the historical shipping data includes domestic shipping data and oceanic shipping data.
